(19) United States
(12) Patent Application Publication
(10) Pub. No.: US 2017/0142488 A1
(43) Pub. Date: May 18, 2017

(54) METHOD FOR RECOMMENDING VIDEOS THROUGH BLUETOOTH, MOBILE TERMINAL AND VEHICLE-MOUNTED VIDEO PLAYER

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Hailan YU, Tianjin (CN); Qin HUANG, Tianjin (CN)

(21) Appl. No.: 15/236,359

(22) Filed: Aug. 12, 2016

Related U.S. Application Data
(63) Continuation of application No. PCT/CN2016/087341, filed on Jun. 27, 2016.

(30) Foreign Application Priority Data
Nov. 13, 2015 (CN) 201510781126.1

(51) Int. Cl. H04N 21/466; H04W 76/02; H04L 29/08; H04L 29/06; G06K 9/00; H04N 21/41; H04N 21/4363; H04N 21/4627; H04N 21/4415; H04N 21/45; H04W 4/00; H04N 21/414

(52) U.S. Cl. CPC H04N 21/4668; H04W 4/008; H04W 76/02; H04L 67/12; H04L 63/0861; H04N 21/41422; H04N 21/4126; H04N 21/43637; H04N 21/4627; H04N 21/4415; H04N 21/4532; G06K 9/00087; H04W 4/12

(57) ABSTRACT

An embodiment of the present disclosure provides a method for recommending videos through Bluetooth, a mobile terminal and a vehicle-mounted video player. The method comprises: establishing Bluetooth connection with the mobile terminal; receiving a new-user notification message transmitted by the mobile terminal through the Bluetooth connection; the new-user notification message comprises user information which is obtained by using the mobile terminal to identify a fingerprint input by a user and to perform identity authentication; recommending videos to users based on the user information. According to the present disclosure, the vehicle-mounted video player is capable of receiving the new-user notification message transmitted by the mobile terminal through Bluetooth connection and recommending the corresponding videos to users according to the user information; users' manual search and input are not needed any more; users' manual operation frequency is reduced and smart service is provided for users.

### CROSS-REFERENCE TO RELATED APPLICATIONS

The present disclosure is a continuation of International Application No. PCT/CN2016/087341, filed on Jun. 27, 2016; which is based upon and claims priority to Chinese Patent Application No. 201510781126.1, entitled “A METHOD FOR RECOMMENDING VIDEOS THROUGH BLUETOOTH, MOBILE TERMINAL AND VEHICLE-MOUNTED VIDEO PLAYER”, file to State Intellectual Property Office of The P.R.C on Nov. 13, 2015, and the entire contents of all of which are incorporated herein by reference.

### TECHNICAL FIELD

The present disclosure generally relates to the technical field of video processing and especially relates to a method of recommending videos through Bluetooth, a mobile terminal and a vehicle-mounted video player.

### BACKGROUND

With the development of industry and manufacturing industry, traveling by car is the best choice. In order to increase the comfort during driving, vehicle-mounted video players are generally installed in automobiles.

An original vehicle-mounted video player only plays the stored videos. Nowadays, the vehicle-mounted video players can access the Internet and provide online videos to users. When watching videos, users need to manually operate the video player to choose what they want to watch, or users use the search function to manually input the names or abbreviations of the desired videos.

Therefore, an urgent technical problem needed to be solved by technicians in this field is how to reduce the frequency of users' manual operation when users use the vehicle-mounted video player to watch videos.

### SUMMARY

The embodiment of the present disclosure provides a method of recommending videos through Bluetooth, a mobile terminal and a vehicle-mounted video player; the present disclosure aims to solve the technical problems that users need to manually search videos and the manual operation times are relatively more in the prior art.

According to one aspect of the present disclosure, the embodiment of the present disclosure discloses a method of recommending videos through Bluetooth; the method is applicable to the vehicle-mounted video player supporting the use of the mobile terminal and includes the steps of:
establishing Bluetooth connection with the mobile terminal;
receiving a new-user notification message, transmitted by the mobile terminal through the Bluetooth connection; the new-user notification message includes user information which is obtained by using the mobile terminal to identify a fingerprint input by user and to perform identity authentication;
recommending videos to users based on the user information.

According to the another aspect of the present disclosure, the embodiment of the present disclosure discloses a method of recommending videos through the Bluetooth; the method includes the steps of:
establishing Bluetooth connection with a vehicle-mounted video player;
identifying a fingerprint input by a user and performing identity authentication on the fingerprint;
if the identity authentication is approved, acquiring the corresponding user information of the fingerprint, in which the user information includes user ID and user name:

transmitting the new-user notification information, including the user information, to the vehicle-mounted video player through the Bluetooth connection.

According to the other aspect of the present disclosure, the embodiment of the present disclosure discloses a vehicle-mounted video player, including: at least one processor; and a memory communicably connected with the at least one processor and for storying instructions executable by the at least one processor, wherein execution of the instructions by the at least one processor causes the at least one processor to:
establish Bluetooth connection with an electronic device;
receive a new-user notification message transmitted by the electronic device through Bluetooth connection; the new-user notification message includes user information which is obtained using the mobile terminal to identify a fingerprint input by a user and to perform identity authentication;
a video recommendation module used for recommending the corresponding videos of the user information to users based on the user information.

According to the other aspect of the present disclosure, the embodiment of the present disclosure discloses an electronic device, including: at least one processor; and a memory communicably connected with the at least one processor and for storying instructions executable by the at least one processor, wherein execution of the instructions by the at least one processor causes the at least one processor to:
establish Bluetooth connection with the vehicle-mounted video player;
identify a fingerprint input from a user by performing the identity authentication on the fingerprint; if the identity authentication is approved, acquire the corresponding user information of the fingerprint; the user information includes the user ID and the user name;

transmit the new-user notification message, including the user information, to the vehicle-mounted video player through the Bluetooth connection.

According to another aspect of the present disclosure, a computer program is provided and includes computer readable codes; when the computer readable codes are run on the vehicle-mounted video player, the vehicle-mounted video player is resulted in implementing the method of recommending videos through the Bluetooth.

According to another aspect of the present disclosure, a computer program is provided and includes computer readable codes; when the computer readable codes are run on the mobile terminal, the mobile terminal is resulted in implementing the method of recommending videos through the Bluetooth.

According to one more aspect of the present disclosure, a computer readable medium is provided and is stored with the computer program.

According to the method of recommending videos through the Bluetooth, the mobile terminal and the vehicle-mounted video player provided by the embodiments of the present disclosure, the vehicle-mounted video player can receive the new-user notification message, transmitted by the mobile terminal through the Bluetooth connection, and can recommend the corresponding videos to users according to the user information; manual searches by the user are no longer needed, users' manual operation frequency is reduced and smart service is provided for users.

The description is only the summary of the technical solution of the present disclosure; in order to understand the technical solutions of the present disclosure more clearly, the technical solutions can be implemented according to the content of the description; moreover, the above-mentioned purpose, the other purposes, features and advantages of the present disclosure can be more obvious and understandable, the following embodiments of the present disclosures are adopted.

### BRIEF DESCRIPTION OF THE DRAWINGS

In order to illustrate the embodiments of the present disclosure or the technical solutions in the prior art more clearly, the drawings to be used in the embodiments or the description of the prior art are simply introduced; obviously, the drawings in the following description are some embodiments of the present disclosure; ordinary technicians in this field can acquire other drawings according to the following drawings without creative work.

FIG. 1 is the step diagram of the method of recommending videos through the Bluetooth according to a first embodiment of the present disclosure.

FIG. 2 is the step diagram of the method of recommending videos through the Bluetooth according to a second embodiment of the present disclosure.

FIG. 3 is the scene diagram of implementing a Bluetooth connection between the mobile terminal and the vehicle-mounted video player, according to a second embodiment of the present disclosure.

FIG. 4 is the structural diagram of a vehicle-mounted video player according to a third embodiment of the present disclosure.

FIG. 5 is the structural diagram of a mobile terminal according to a fourth embodiment of the present disclosure.

FIG. 6 schematically illustrates a block diagram of the electronic device used for implementing the method of the present disclosure.

FIG. 7 schematically illustrates a memory cell used for storing or carrying program codes used for realizing the method of the present disclosure.

### DETAILED DESCRIPTION

In order to make the purposes, technical solutions and advantages of the embodiment of the present disclosure more clear, the technical solutions in the embodiment of the invention are clearly and completely described in combination with the drawings in the embodiment of the invention; the described embodiments are not all the embodiments, but part of the embodiments of the present disclosure. Based on the embodiments of the present disclosure, other embodiments obtained by ordinary technicians without creative work belong to the protective scope of the present disclosure.

### First Embodiment

FIG. 1 shows the step diagram of the method of recommending videos, provided by the first embodiment of the present disclosure, through Bluetooth.

The first embodiment of the present disclosure provides a method for recommending videos through the Bluetooth and the method is applicable to the vehicle-mounted video player and is shown in FIG. 1; the method includes the steps as follows:

Step S101, establishing Bluetooth connection with the mobile terminal.

In this step, the vehicle-mounted video player can establish Bluetooth connection with the mobile terminal through the SDP (Service Discovery Protocol). The mobile terminal is the one matched with the vehicle-mounted video player and has a user fingerprint acquisition function. The mobile terminal can be the terminals, such as mobile phones or tablet computer, with fingerprint acquisition functions.

Step S102, receiving the new-user notification message, transmitted by the mobile terminal, through the Bluetooth connection.

In this step, the new-user notification message includes the user information; the user information is obtained by using the mobile terminal to identify a fingerprint input by a user and implementing identity authentication. The vehicle-mounted video player can receive the new-user notification message, transmitted by the mobile terminal, in the way of configuring the user information service characteristic descriptor and the recommendation service descriptor. The user information includes user ID (Identification) and user name and certainly can include other information.

Step S103, recommending the corresponding videos of the user information for users according to the user information.

In this step, the corresponding videos of the user information can be the videos which are recommended by analyzing users' watching behaviors and recommended to users according to the analysis results.

The embodiments of the present disclosure provide a method of preferably recommending videos to users; the corresponding watching history of the user information is acquired according to the user information and videos in the same type of the watching history are recommended to users. Of course, the latest pushed videos such as the latest movies can be recommended to users; high-popularity videos such as Nirvana in Fire can also be recommended; videos featuring the same actors and directed by the same director can also be recommended to users. The users' watching frequency of the videos can be improved, users' manual search of the videos is not needed and users' manual operation frequency is reduced.

According to the method of recommending videos through the Bluetooth provided by the first embodiment of the present disclosure, the new-user notification message, transmitted by the mobile terminal, can be received through the Bluetooth connection; the corresponding videos can be recommended to users according to the user information; users' manual search is not needed any more, users' manual operation frequency is reduced and smart service is provided for users.

### Second Embodiment

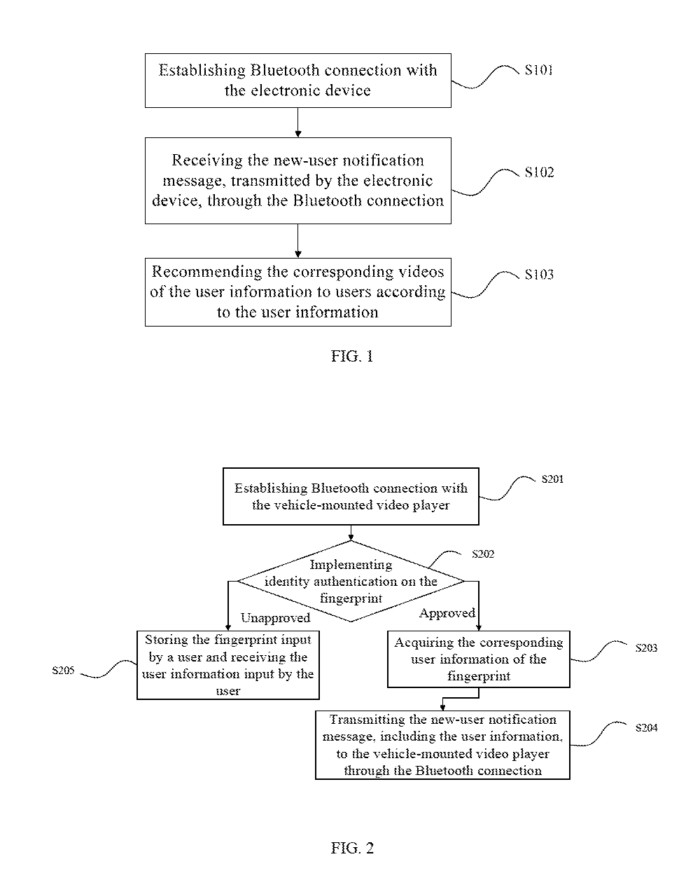

FIG. 2 shows the step diagram of the method of recommending videos through the Bluetooth, provided by the second embodiment of the present disclosure.

The second embodiment of the present disclosure provides a method of recommending videos through the Bluetooth; the method can be implemented by the mobile terminal matched with the vehicle-mounted video player shown in FIG. 2; the method includes the steps as follows.

Step S201, establishing Bluetooth connection with the vehicle-mounted video player.

In this step, the mobile terminal can be in Bluetooth connection with the vehicle-mounted video player through the SDP.

Step S202, identifying a fingerprint input by a user and performing identity authentication on the fingerprint.

In this step, the identity authentication is identifying who the user of inputting the fingerprint is and distinguishing the user and the other users of the vehicle-mounted video player. The present disclosure provides a method for preferably performing identity authentication on the fingerprint; the method includes the steps of: identifying the fingerprint input by the user and comparing the fingerprint with at least one pre-stored fingerprint; if the similarity between the fingerprint and any pre-stored fingerprint exceeds the threshold value, acquiring the corresponding user information of the pre-stored fingerprint. The pre-stored fingerprint can be the fingerprint input by the vehicle-mounted video player user in advance. If the identity authentication is approved, executing the step S203; if not, executing the step S205.

Step S203, acquiring the corresponding user information of the fingerprint; the user information includes user ID and user name.

In this step, while storing the fingerprint, the user's smart mobile terminal stores the corresponding user information of the fingerprint.

Step S204, transmitting the new-user notification message, including the user information, to the vehicle-mounted video player through the Bluetooth connection.

Step S205, storing the fingerprint input by the user and receiving the user information input by the user.

In this step, if the mobile terminal does not store the user's fingerprint and cannot identify the user's identity, the user is a new user without using the method of recommending videos through the Bluetooth; therefore, the mobile terminal can store the fingerprint input by the user and receive the user information input by the user, so that the mobile terminal can successfully implement identity authentication and obtain the corresponding videos recommended by the vehicle-mounted video player when the user next inputs the fingerprint.

According to the method of recommending videos through the Bluetooth provided by the second embodiment of the present disclosure, the user's fingerprint and the corresponding information can be stored in the mobile terminal; when the user inputs the fingerprint, the mobile terminal can identify the user's identity according to the pre-stored fingerprint, transmit the new-user notification message, including the user information, to the vehicle-mounted video player and acquire the relative videos recommended by the vehicle-mounted video player; in this process, the user only needs to input the fingerprint and the user's manual operation frequency is reduced obviously.

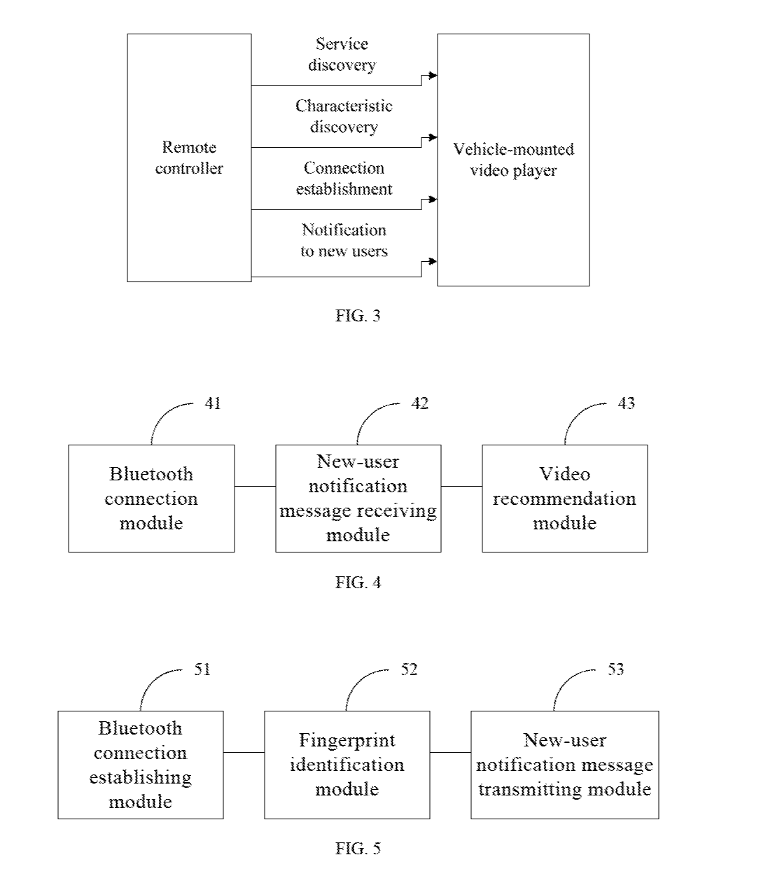

According to the embodiments of the present disclosure, the mobile terminal establishes the Bluetooth connection with the vehicle-mounted video player and transmits the new-user notification message to the vehicle-mounted video player as shown in FIG. 3; in FIG. 3, the mobile terminal receives the UUID broadcast by the vehicle-mounted video player; according to the UUID, the mobile terminal performs service discovery, discovers the User Information Service and the Recommendation Service and discovers the user information service characteristic descriptor and the recommendation service descriptor through characteristic discovery; the user information service characteristic descriptor and the recommendation service descriptor are configured on the user information, so that the Bluetooth connection is established; after the establishment of the Bluetooth connection, the mobile terminal can transmit the new-user notification message to the vehicle-mounted video player.

### Third Embodiment

FIG. 4 is the structural diagram of a vehicle-mounted video player provided by the third embodiment of the present disclosure.

The third embodiment of the present disclosure provides a vehicle-mounted video player; the vehicle-mounted video player is capable of implementing the method of recommending videos through the Bluetooth provided by the first embodiment of the present disclosure and is shown in FIG. 4; the vehicle-mounted video player includes a Bluetooth connection module 41, a new-user notification message receiving module 42 and a video recommendation module 43.

In the third embodiment of the present disclosure, the Bluetooth connection module 41 is used for establishing a Bluetooth connection with the mobile terminal; the new-user notification message receiving module 42 is used for receiving the new-user notification message transmitted by the mobile terminal through the Bluetooth connection; the new-user notification message includes the user information which is obtained by using the mobile terminal to identify the finger input by the user and to implement the identity authentication; the video recommendation module 43 is used for recommending the corresponding videos of the user information to users according to the user information.

In the Bluetooth connection module 41, the vehicle-mounted video player can establish Bluetooth connection with the mobile terminal through the SDP. The mobile terminal is the one matched with the vehicle-mounted video player and has a user's fingerprint acquisition function.

In the new-user notification message receiving module 42, the new-user notification message includes the user information which is obtained by using the mobile terminal to identify the finger input by the user and to implement the identity authentication. The vehicle-mounted video player can receive the new-user notification message, transmitted by the mobile terminal, in the way of configuring the user information service characteristic descriptor and the recommendation service descriptor. The user information includes the user ID and the user name and can include other information.

In the video recommendation module 43, the corresponding videos of the user information can be the videos which are recommended by analyzing users' watching behaviors and recommended to users according to the analysis results. Preferably, the video recommendation module 43 acquires the corresponding watching history of the user information according to the user information and recommends the videos of the same type as those in the user's watching history. Of course, the latest push-delivery videos such as the latest movies can be recommended to users; high-popularity videos such as Nirvana in Fire can also be recommended; videos acted by the same actors and directed by the same director can also be recommended to users. The users' watching frequency of the videos can be improved, users' manual search of the videos is not needed and users' manual operation frequency is reduced.

According to the vehicle-mounted video player provided by the third embodiment of the present disclosure, the new-user notification message, transmitted by the mobile terminal, can be received through the Bluetooth connection; the corresponding videos can be recommended to users according to the user information; users' manual search is not needed any more, users' manual operation frequency is reduced and smart service is provided for users.

### Fourth Embodiment

FIG. 5 is the structural diagram of a mobile terminal provided by the fourth embodiment of the present disclosure.

The fourth embodiment of the present disclosure provides a mobile terminal; the mobile terminal can implement the method of recommending videos through the Bluetooth provided by the second embodiment of the present disclosure; the mobile terminal is shown in FIG. 5 and includes a Bluetooth connection establishing module 51, a fingerprint identification module 52 and a new-user notification message transmitting module 53.

According to the fourth embodiment of the present disclosure, the Bluetooth connection establishing module 51 is used for establishing a Bluetooth connection with a vehicle-mounted video player; the fingerprint identification module 52 is used for identifying fingerprint input by a user and performing the identity authentication on the fingerprint, if the identity authentication is approved, the corresponding user information of the fingerprint is acquired; the user information includes the user ID and the user name; the new-user notification message transmitting module 53 is used for transmitting the new-user notification message, including the user information, to the vehicle-mounted video player through the Bluetooth connection.

The Bluetooth connection establishing module 51 includes the following modules: a UUID receiving unit is used for receiving the UUID broadcast by the vehicle-mounted video player; a service discovery unit is used for discovering the user information service and the recommendation service according to the UUID and discovering the user information service characteristic descriptor and the recommendation service descriptor through the characteristic discovery; a descriptor configuration unit is used for configuring the user information service characteristic descriptor and the recommendation service descriptor on the user information. Therefore, the Bluetooth connection establishing module 51 establishes a Bluetooth connection with the vehicle-mounted video player.

In the fingerprint identification module 52, the identity authentication is identifying who the user of inputting the fingerprint is, and distinguishing the user and the other users of the vehicle-mounted video player. The present disclosure provides a method for preferably performing identity authentication on the fingerprint, the method includes the steps of: identifying the fingerprint input by the user and comparing the fingerprint with at least one pre-stored fingerprint; if the similarity between the fingerprint and any pre-stored fingerprint exceeds the threshold value, acquiring the corresponding user information of the pre-stored fingerprint. The pre-stored fingerprint can be the fingerprint input by the vehicle-mounted video player user in advance.

According to a mobile terminal provided by the fourth embodiment of the present disclosure, the mobile terminal can store the user's fingerprint and the corresponding information of the fingerprint; when a user inputs a fingerprint, the mobile terminal can identify the user's identity according to the pre-stored fingerprint and transmit the new-user notification message, including the user information, to the vehicle-mounted video player so as to acquire the relative videos recommended by the vehicle-mounted video player; in this process, the user only needs to input the fingerprint and user's manual operation frequency is obviously reduced.

The described device embodiments are only schematic; units described as separating parts can be or cannot be physically separated; unit displaying parts may or may not be physical units, that is, the unit displaying parts may be located at the same position or distributed on a plurality of network units. According to actual demands, the purposes of the solutions in the present embodiments are realized by choosing all or some modules. The ordinary technicians in the field can understand and implement the embodiment without creative work.

Each of devices according to the embodiments of the disclosure can be implemented by hardware, or implemented by software modules operating on one or more processors, or implemented by the combination thereof. A skilled person in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

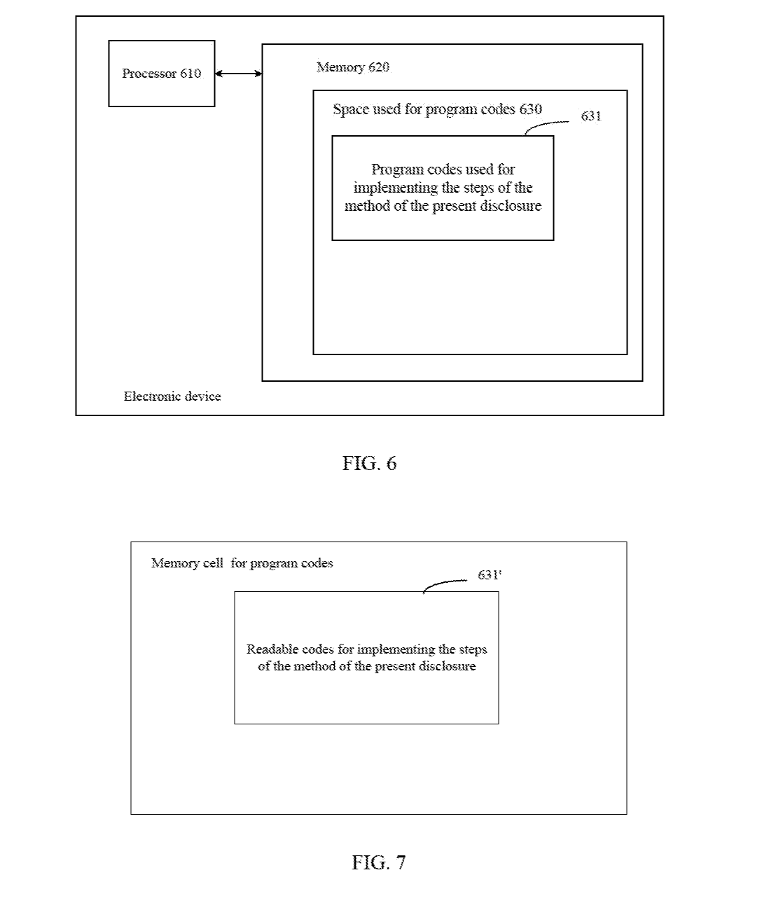

For example, FIG. 6 illustrates a block diagram of an electronic device for executing the method according the disclosure, such as the vehicle-mounted player or mobile terminal above. Traditionally, the electronic device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed for example in an appropriate form. Usually, the memory cell includes computer readable codes 631′ which can be read for example by processors 610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the skilled person in the art without departing from the scope of claims as appended. In the claims, any reference symbols between brackets form no limit of the claims. The word “include” does not exclude the presence of elements or steps not listed in a claim. The word “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it is illustrated that the above embodiments are only used for describing the technical solutions of the present disclosure and are not affirmed to be restricted to the technical solutions; the present disclosure is described in details according to the above-mentioned embodiments, thus the ordinary technicians in the field shall understand that technical solutions recorded in each embodiment still can be amended or some technical characteristics thereof can be substituted equally; these amendments or substitutions do not diminish their essential reliance on the spirits and scopes of the technical solutions in each embodiment of the present disclosure.

What is claimed is:

1. A method of recommending videos through Bluetooth adapted to a vehicle-mounted video player, wherein the method comprises:
establishing Bluetooth connection with the mobile terminal;
receiving a new-user notification message transmitted by the mobile terminal through the Bluetooth connection; the new-user notification message comprising user information which is obtained by using the mobile terminal to identify a fingerprint input by a user and to perform identity authentication;
recommending videos to users based on the user information.

2. The method according to claim 1, wherein the user information comprises user ID and user name.

3. The method according to claim 1, further comprising:
acquiring the watching history based on the user information and recommending videos in the same type of the watching history to the users.

4. The method according to claim 1, further comprising:
configuring a user information service characteristic descriptor and a recommendation service descriptor, and receiving the new-user notification message transmitted by the mobile terminal.

5. A method of recommending videos through Bluetooth, comprising:
establishing Bluetooth connection with a vehicle-mounted video player;
identifying a fingerprint input by a user and performing identity authentication on the fingerprint;
acquiring, if the identity authentication is approved, the corresponding user information of the fingerprint, in which the user information comprises user ID and user name;
transmitting the new-user notification information including the user information to the vehicle-mounted video player through the Bluetooth connection.

6. The method according to claim 5, further comprising:
identifying the fingerprint input by the user and comparing the fingerprint with at least one pre-stored fingerprint;
acquiring, if the similarity between the fingerprint and any pre-stored fingerprint exceeds a threshold value, the corresponding user information of the pre-stored fingerprint.

7. The method according to claim 5, further comprising:
receiving the UUID broadcast by the vehicle-mounted video player,
discovering a user information service and a recommendation service according to the UUID, and discovering the user information service characteristic descriptor and the recommendation service descriptor through characteristic discovery;
configuring the user information service characteristic descriptor and the recommendation service descriptor on the user information.

8. A vehicle-mounted video player comprising:
at least one processor; and
a memory communicably connected with the at least one processor and for storying instructions executable by the at least one processor, wherein execution of the instructions by the at least one processor causes the at least one processor to:
establish Bluetooth connection with an electronic device;
receive a new-user notification message transmitted by the electronic device through the Bluetooth connection; the new-user notification message comprises user information which is obtained by using the mobile terminal to identify a fingerprint input by a user and to perform identity authentication;
recommend the corresponding videos of the user information to users based on the user information.

9. The vehicle-mounted video player according to claim 8, wherein the user information comprises user ID and user name.

10. The vehicle-mounted video player according to claim 8, wherein the at least one processor is further configured to: acquire the corresponding watching history of the user information according to the user information and recommending videos that match the user's watching history to the users.

11. The vehicle-mounted video player according to claim 8, wherein the at least one processor is further configured to: configure a user information service characteristic descriptor and the recommendation service descriptor and receive the new-user notification message transmitted by the mobile terminal.

12. A electronic device comprising:
at least one processor; and
a memory communicably connected with the at least one processor and for storying instructions executable by the at least one processor, wherein execution of the instructions by the at least one processor causes the at least one processor to:
establish Bluetooth connection with a vehicle-mounted video player,
identify a fingerprint input from a user by performing the identity authentication on the fingerprint; if the identity authentication is approved, acquire the corresponding user information of the fingerprint; the user information comprises the user ID and the user name;
transmit the new-user notification message, including the user information, to the vehicle-mounted video player through the Bluetooth connection.

13. The electronic device according to claim 12, wherein the at least one processor is further configured to:
identify the fingerprint input from the user and compare the fingerprint with at least one pre-stored fingerprint; if the similarity between the fingerprint and any pre-stored fingerprint exceeds a threshold value, acquire the corresponding user information of the pre-stored fingerprint.

14. The electronic device according to claim 12, wherein the at least one processor is further configured to:
receive the UUID broadcast by the vehicle-mounted video player;
discover the user information service and the recommendation service according to the UUID, and discover the user information service characteristic descriptor and the recommendation service descriptor through the characteristic discovery;
configure the user information service characteristic descriptor and the recommendation service descriptor on the user information.
